(19) United States
(12) Patent Application Publication
(10) Pub. No.: US 2008/0256355 A1
(43) Pub. Date: Oct. 16, 2008

(54) Communication Apparatus, Control Method For A Communication Apparatus, Computer Program Product, And Computer Readable Storage Medium

(76) Inventor: Yuuji Takemoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/867,166

(22) Filed: Oct. 4, 2007

(30) Foreign Application Priority Data
Oct. 4, 2006 (JP) 2006-273235
Jul. 4, 2007 (JP) 2007-176405

(51) Int. Cl. H04L 9/28

(52) U.S. Cl. 713/153

(57) ABSTRACT

A communication apparatus for outputting e-mail to a network including a storing part configured to store e-mail addresses and related encryption information signifying whether e-mail directed to the addresses should be encrypted or in plain text; a displaying part configured to display the e-mail addresses stored in the storing unit as selectable destinations by a user; a receiving part configured to receive an instruction to encrypt e-mail or keep the e-mail in plain text for addresses selected as destinations via the displaying part; an e-mail control part configured to control creation of the e-mail based on the instruction received by the receiving part and the encryption information related to the selected e-mail addresses; and an output part configured to output the created e-mail through the e-mail control part to the network.

### RELATED APPLICATIONS

This application claims the benefit of Japanese Patent Application No. 2006-273235 filed on 4 Oct. 2006 and Application No. 2007-176405 filed on 4 Jul. 2007 in the Japanese Patent Office, the disclosures of which are hereby incorporated by reference.

### BACKGROUND OF THE INVENTION

1. Field of the Invention

The present invention relates to a communication apparatus, and a control method for a communication apparatus having encryption capability.

2. Description of the Related Art

Many communication apparatuses are able to encrypt an e-mail with PGP (Pretty Good Privacy) or S/MIME (Secure Multipurpose Internet Mail Extensions) in order to be secure when the apparatuses send or receive e-mail over networks such as LAN or the Internet, for example. S/MIME is described in RFC2311, RFC2312, RF2632, and RF2633. PGP/MIME is described in RFC 1991, RFC2015. Since S/MIME uses the PKI (Public Key Infrastructure) based on X.509 recommended by the ITU (International Telecommunication Union), clients using S/MIME need to communicate a certificate to each other. An application software able to use a function of S/MIME is installed in each client computer and the client computers send or receive the e-mail securely over a network.

Technologies related to secure e-mail communication such as S/MIME or PGP are described in Patent Document 1, JP2002-222143A, Patent Document 2, JP2001-320362A, Patent Document 3, JP2002-368823A, and Patent Document 4, JP2003-296250A.

According to the encryption method for e-mail described in the above Patent Documents, the users have to encrypt each e-mail. Furthermore, they have to take care whether they send the e-mail encrypted or with plain text when they input an address for the e-mail. Moreover, if they send e-mail to multiple addresses according to the address book registered in the communication apparatus, the communication apparatus encrypts the e-mail uniformly. So it takes time to send e-mail to multiple addresses in the case where the sender wants to encrypt the email sent to some addresses, but wishes to send the email in plain text to the remaining addresses.

In addition, it has been difficult for the sender to confirm whether a selected address is able to receive an encrypted e-mail or not prior to sending the email.

### SUMMARY OF THE INVENTION

It is an object of the present invention to overcome the deficiencies described above, and to provide a communication apparatus which reduces the user's concern whether e-mail should be encrypted or sent in a plain text for one or more addresses.

It is a further object of the present invention to provide a control method for using a communication apparatus to implement the encryption scheme of the present invention.

### BRIEF DESCRIPTION OF THE DRAWINGS

FIG. 1 is a diagram illustrating an example of an external view of a communication apparatus.

FIG. 2 is a diagram illustrating an example of a hardware layout of the communication apparatus.

FIG. 3 is a diagram illustrating software functions of the communication apparatus.

FIG. 4 is a diagram illustrating an example of an address data structure of an address book in the communication apparatus.

FIG. 5 is a diagram illustrating an example of the address book in the communication apparatus.

FIG. 6 is a diagram illustrating an example of an operation panel of the communication apparatus.

FIG. 7 is a flow chart illustrating a process conducted by the communication apparatus after actuating the application key shown in FIG. 6.

FIG. 8 is a diagram illustrating an example of a screen displayed by the operation panel illustrated in FIG. 6.

FIG. 9 is a flow chart illustrating a process of sending encrypted e-mail using the communication apparatus.

FIG. 10A and FIG. 10B are diagrams illustrating an example of a warning message displayed by the operation panel illustrated in FIG. 6.

FIG. 11 is a flow chart illustrating an example of sending e-mail to multiple addresses after displaying one of the warning messages illustrated in FIG. 10A and FIG. 10B.

FIG. 12A and FIG. 12B are diagrams illustrating another example of warning messages displayed by the operation panel illustrate by FIG. 6 according to an additional embodiment.

FIG. 13 is a flow chart illustrating an example of sending e-mail in plain text using the communication apparatus.

FIG. 14A and FIG. 14B are diagrams illustrating an example of a warning message displayed by the operation panel illustrated in FIG. 6 according to an additional embodiment.

FIG. 15 is a flow chart illustrating an example of sending e-mail to multiple addresses after displaying one of the warning message illustrated in FIG. 14 A and FIG. 14B.

FIG. 16A and FIG. 16B are diagrams illustrating examples of a warning message displayed by the operation panel illustrated in FIG. 6 according to an additional embodiment.

FIG. 17 is a diagram illustrating an example of a record (i.e., a log) of e-mail sent displayed by the operation panel illustrated in FIG. 6.

FIG. 18 is a diagram illustrating another example of a data structure of the address book in the communication apparatus.

FIG. 19 is diagram illustrating another example of an address book stored in the communication apparatus.

FIG. 20 is a flow chart illustrating another process conducted by the communication apparatus in response to actuating the application key illustrated in FIG. 6.

FIG. 21 is a diagram illustrating an example of a warning message displayed by the operation panel illustrated in FIG. 6 according to an additional embodiment.

FIG. 22 is a flow chart illustrating another process conducted by the communication apparatus.

### DESCRIPTION OF THE PREFERRED EMBODIMENTS

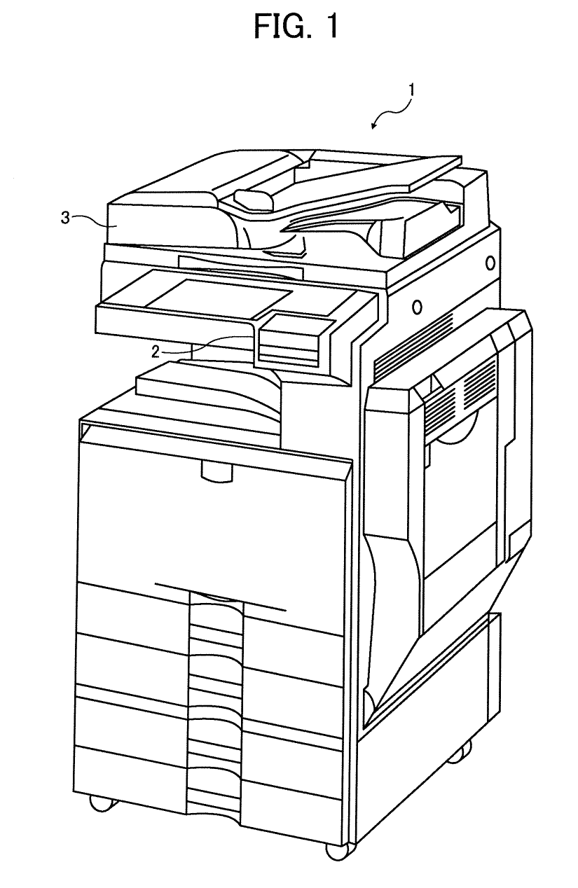

In the following, embodiments of the present invention will be described with reference to the accompanying drawings. First, an example of an external view of a communication apparatus 1 is illustrated in FIG. 1. The communication apparatus 1 is a Multi Function Device (MFD) which has a copy function, print function, scan function, and facsimile function. The communication apparatus 1 has an operation panel 2, and a document reading unit 3. For the sake of convenience, the communication apparatus 1 will be referred to as the MFD 1 in the following description.

The operation panel 2 includes a plurality of keys with which a user operates the MFD 1 and a display. The document reading unit 3 is a reading device which reads a document and generates an image, such as a scanner device.

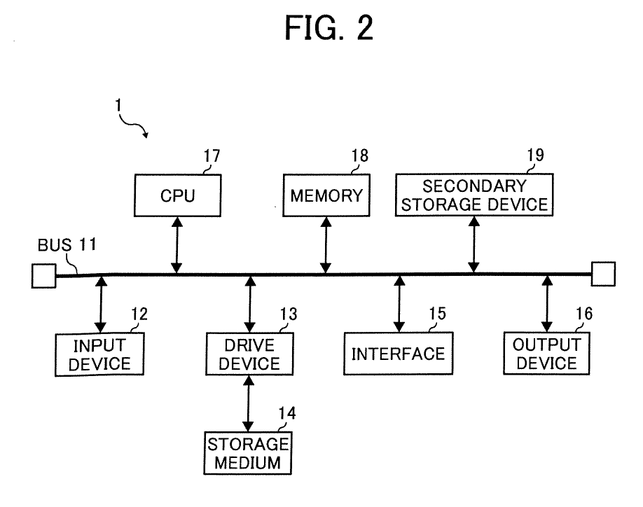

An example of a hardware layout of the MFD 1 is shown in FIG. 2. The MFD 1 includes an input device 12, a drive device 13, an interfacing device 15, an outputting device 16, a CPU 17, a memory device 18, and a storage device 19. Those devices are connected to each other over a bus 11.

The input device 12 is a device for inputting user operations of the MFD 1, such as the operation panel 2 illustrated in FIG. 2. The drive device 13 is a device for reading a recording medium 14 such as a CD-ROM. If the recording medium 14 is an SD card, the drive device 13 is an SD card slot, and if the recording medium 14 is an FD, the drive device 13 is an FDD drive, for example.

The recording medium 14 stores a program for implementing functions of the MFD 1. The program is a control program in this embodiment. The interfacing device 15 enables the MFD 1 to connect to a network such as a LAN, the Internet, etc.

The outputting device 16 is a printer unit, a plotter unit, or a facsimile unit, for example. The CPU 17 processes data according to the control program stored in a memory device 18 after the MFD 1 is booted up. The memory device 18 stores the control program or data until the MFD is turned off. For example, the memory device 18 reads the control program from a secondary storage device 19. In addition, the memory device 18 stores data used by the control program.

The external storage device 19 stores the control program and the data, and can be for example a HDD. The control program stored by the recording medium 14 is transferred to the secondary storage device 19 via the drive device 13.

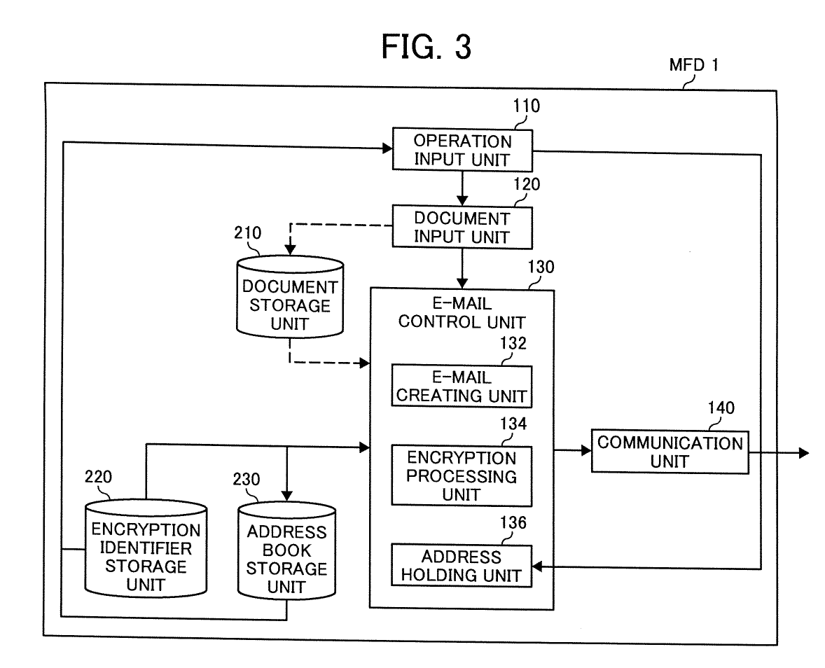

FIG. 3 is a diagram illustrating an example of software functions of the MFD 1 according to a first embodiment. As shown in FIG. 3, the MFD 1 has an operation input unit 110, a document input unit 120, an e-mail control unit 130, a communication unit 140, a document storage unit 210, an encryption identifier storage unit 220, and an address book storage unit 230. In addition, the e-mail control unit 130 further includes an e-mail creating unit 132, an encryption processing unit 134, and an address information holding unit 136.

The operation input unit 110 displays an address book stored in the address book storage unit 230 or an encryption identifier stored in the encryption identifier storage unit 220 on the operation panel 2, and receives instructions input by a user.

The document input unit 120 inputs a document as electronic data based on an instruction to input the document received from the operation input unit 110, and stores the data in the document storage unit 210. For example, the document is input from the document reading unit 3 as shown in FIG. 1 or may be input from a network.

The e-mail control unit 130 controls the e-mail creating unit 132, the encryption processing unit 134, and the address information holding unit 136 to process the e-mail. The e-mail creating unit 132 creates an e-mail for an address held in the address information holding unit 136. The e-mail has header information and a message body, and the message body is encrypted by the encryption processing unit 134 as needed. The encryption processing unit 134 encrypts the message body of e-mail. The address information holding unit 136 holds e-mail address information displayed on the operation input unit 110 or selected by the user as destination information.

The communication unit 140 sends e-mail created by the e-mail creating unit 132 to the network, more specifically sends it to an external device, such as a personal computer, a server computer, or another MFD, which is connected to the network. The communication unit 140 may be embedded in the e-mail control unit 130.

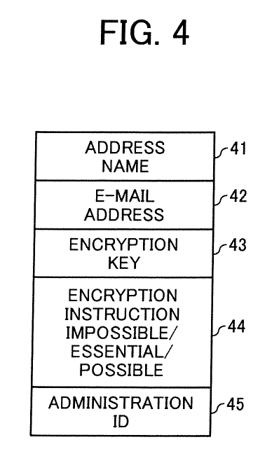

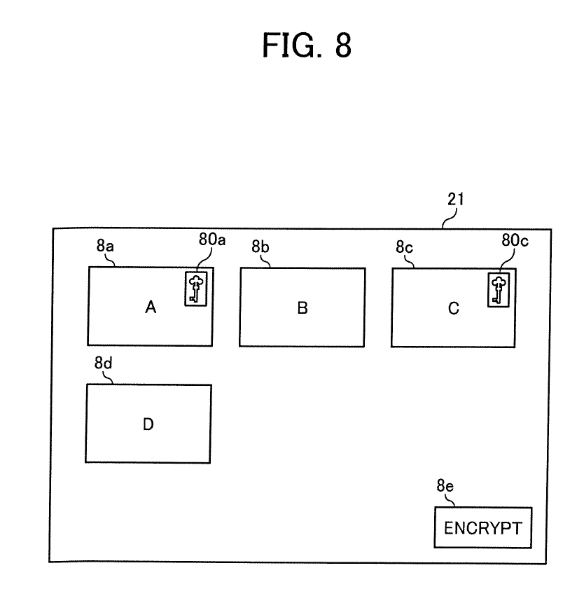

The document storage unit 210 stores electronic data input by the document input unit 120. The encryption identifier storage unit 220 stores the encryption identifier which represents secure information (e.g., key-mark image data or a lock-mark image data). See for example, the key-mark 80a of FIG. 8. The address book storage unit 230 stores an address book which relates each address with encryption instruction information described with reference to FIG. 4.

FIG. 4 is a diagram illustrating an example of an address data structure of the address book stored in the address book storage unit 230. The address data structure includes an address name 41, e-mail address 42, encryption key 43, encryption instruction 44, and administration ID 45. The address name 41 indicates a name associated with the email address, such as a user name, registered in the address book. The e-mail address 42 indicates an e-mail address of the address. The encryption key 43 indicates an encryption key such as a public key or common (shared) key. The encryption instruction 44 indicates whether e-mail to the associated email address should be encrypted. For example, the value “IMPOSSIBLE” means e-mail directed to the address 42 cannot be encrypted. The value “IMPOSSIBLE” is used if an encryption key 43 isn't registered in the address data structure for the associated email address. An “ESSENTIAL” value means the e-mail must be encrypted, and a “POSSIBLE” value means the e-mail can be encrypted, but is not required. Whether the encryption instruction 44 is set to “ESSENTIAL” or “POSSIBLE” depends on the user's setting when registering the corresponding addresses in the address book. The administration ID 45 indicates an identifier issued by the MFD 1 to manage the address data and is held by the address information holding unit.

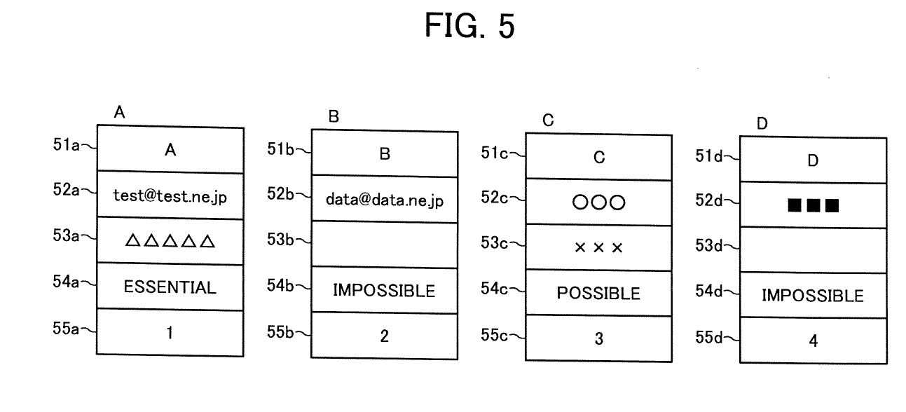

Examples of the data stored in the address data structure will be described with reference in FIG. 5. In FIG. 5, there are four address data structures illustrated corresponding to the user A, user B, user C, and user D.

With regard to the data structure A, an area 51a corresponds to the address name and the user name “A” is registered therein. An area 52a corresponds to the e-mail address 42 and the e-mail address “test1test.ne.jp” is registered therein. An area 53a corresponds to the encryption key 43 and the encryption key “ΔΔΔΔΔ” is registered therein. An area 54a corresponds to the encryption instruction 44 and the instruction “ESSENTIAL” is registered therein. An area 55a corresponds to the administration ID 45 and the ID “1” is registered therein.

The encryption instruction in the area 54b of structure B is “IMPOSSIBLE” because an encryption key isn't registered in the area 53b.

The structure C is the same as the structure A, but the encryption instruction in the area 54c is “POSSIBLE”.

The structure D is the same as the structure B. In particular, the encryption instruction in the area 54d is “IMPOSSIBLE” same as structure B.

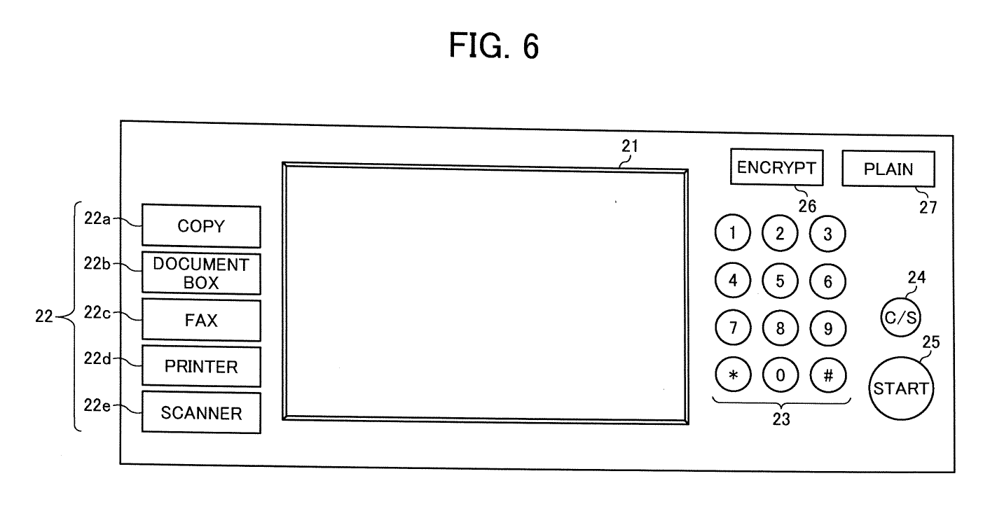

Next, operation of the MFD 1 using the address data structure described above will be described. FIG. 6 is an example of the operation panel of the MFD 1 as shown in FIG. 1. The operation panel includes application keys 22, a touch panel 21, keypad 23, a clear/stop key 24, a start key 25, an encrypt key 26, and a plain text key 27. The touch panel 21 displays a variety of information described below.

The application keys 22 include a copy key 22a to initiate the copy function, a document store key 22b to initiate storage of the document data, a FAX key 22c to initiate sending data as facsimile, a printer key 22d to initiate printing stored document data or configuring print settings, and a scanner key 22e to initiate scanning documents and sending the scanned documents with e-mail or to a folder on the system.

The key pad 23 includes ten numbered-keys, an asterisk key, and an enter (#) key, for example. The clear/stop key 24 is used to clear the settings of a job or to stop a job from running. The start key 25 is used to start an image formation process.

The encrypt key 26 initiates an instruction to encrypt e-mail when the MFD 1 sends e-mail to the address selected by the user. The plain text key 27 initiates an instruction to maintain the plain text of an e-mail when the MFD 1 sends the e-mail to the address selected by the user.

Instead of responding to actuation of the encrypt key 26 or the plain text key 27, actuation of the start key 25 may detect an instruction to encrypt or maintain the plain text of an email. In addition, the encrypt key 26 and plain key 27 may be a soft key instead of a hard key.

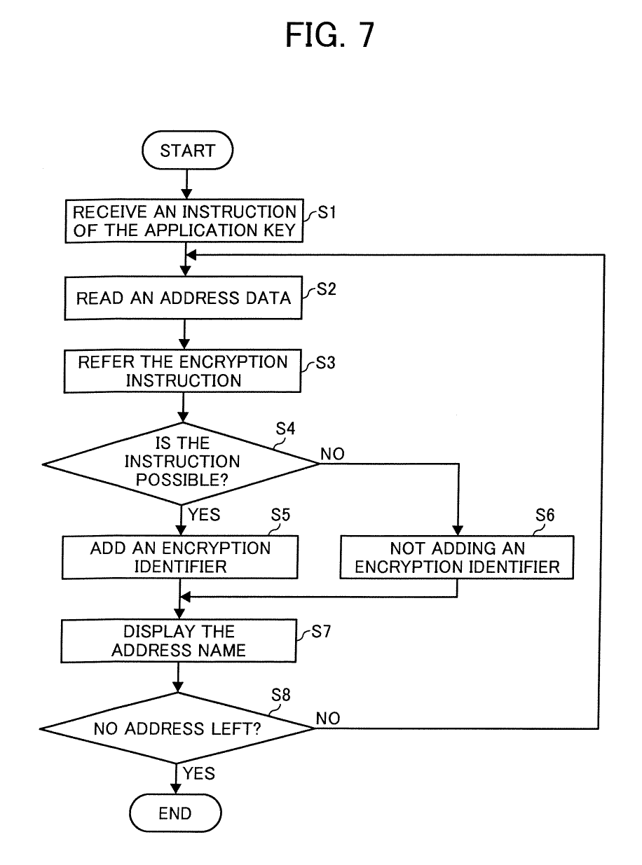

Now the process of displaying the address information on the touch panel 21 will be described using the flowchart of FIG. 7. An example of displaying the address book stored in the address book storage unit 230 in the MFD 1 will be used.

The operation input unit 110 receives an instruction initiated by actuation of one of the application keys 22, for example, entering the scanner key 22e, in step S1. Based on the instruction, the operation input unit 110 reads address data from the address book storage unit 230 in step S2. In this step, the operation input unit 110 reads one address from the address book storage unit 230.

In step S3, the operating input unit 110 refers to the encryption instruction corresponding to the address data read from the address book storage unit 230 in step S2. The operation input unit 110 determines that the encryption instruction is “ESSENTIAL” if the read address belongs to the user A, for example.

By checking the encryption instruction, the operation input unit 110 recognizes whether the referred encryption instruction is “POSSIBLE” or “ESSENTIAL”, at step S4. The operation input unit 110 reads the encryption identifier from the encryption identifier storage unit 220 and adds the identifier to the address data read in step S2 if the referred instruction is “POSSIBLE” or “ESSENTIAL”, in step S5. On the other hand, if the encryption instruction value is “IMPOSSIBLE”, the operation input unit 110 reads neither the encryption identifier (as no encryption identifier is available to be read) nor adds it to the address data, in step S6.

In step S7, the operation input unit 110 displays the address name, such as the user name, of the address data read in step S2. In the step S7, the address name is displayed with the encryption identifier such as the key-mark on the touch panel 21 if the corresponding address data has the value “POSSIBLE” or “ESSENTIAL”, but it doesn't display the identifier in the case where the value is “IMPOSSIBLE”, as shown in FIG. 8.

In step S8, the operation input unit 110 checks whether any address data remains. If no address data remain, the operation input unit 110 ends the process. But, if address date remains, the operation input unit 110 returns to step S2 and continues the process. In the displaying process just described above, the checking step is after the displaying step, but those steps may be reversed.

As a result of the display process, a screen as shown in FIG. 8 is displayed on the touch panel 21. The screen displays destination addresses from the address book and it includes address name icons 8a to 8d, the key marks 80a and 80c, and an encrypt key 8e. From this screen, the user can select the destinations for an email.

Each icon illustrated in FIG. 8 corresponds to the address data in the display process of FIG. 7. The address name icons 8a and 8c are displayed with the key mark 80a and 80c as the encryption identifiers. The address name icons 8b and 8d are displayed with no encryption identifier. So long as it is possible for the user to recognize whether it is possible to encrypt e-mail directed to the respective addresses, it is all right to use other designs as the encryption identifier instead of the key mark.

The encrypt key 8e is used to encrypt e-mail for all the displayed addresses. If the start key 25 shown in FIG. 6 is entered without entering the encryption key 8e, the MFD 1 doesn't encrypt the e-mail for the selected address and sends the email to those destinations in plain text. Thus, the MFD 1 displays the information about the destination addresses based on the address data stored in the address book storage unit 230 so that the user may recognize by each address name icon whether or not it is possible to encrypt e-mail to be transferred to the address.

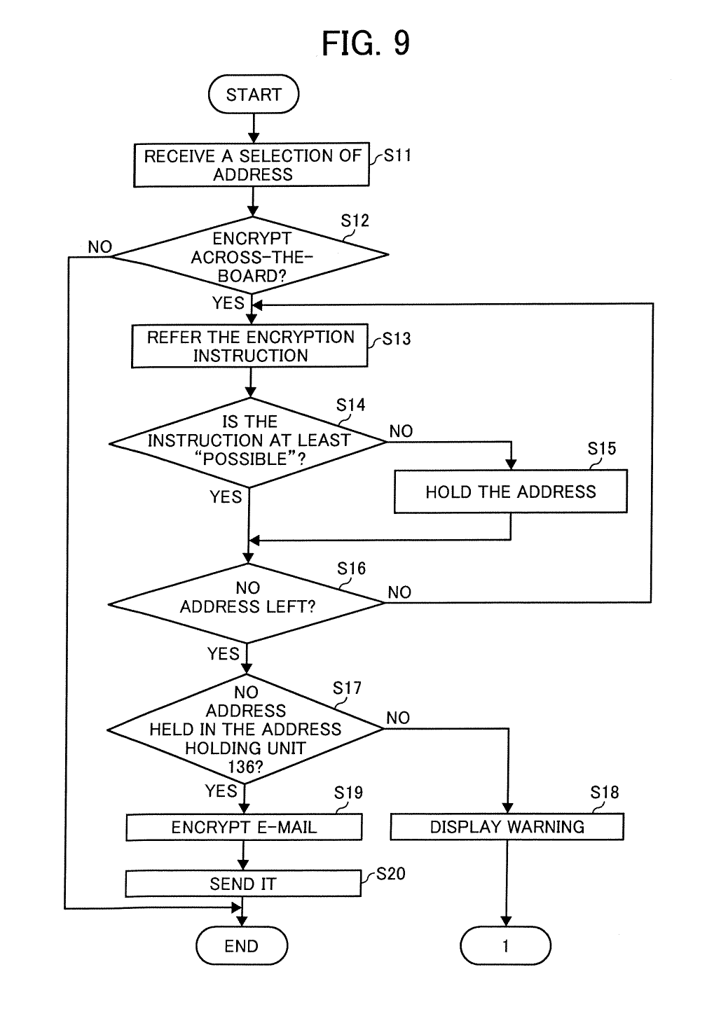

Next, the process of sending e-mail according to this embodiment will be described using FIG. 9. In step S11, the operation input unit 110 receives a selection of an address among the destination addresses displayed on the touch panel 21. Information regarding a selected address such as the administration ID 45 is provided to the address information holding unit 136 and the unit 136 holds the address information.

In step S12, the operation input unit 110 confirms whether the e-mail to be transferred is to be encrypted for all of the displayed destination addresses (i.e., across the board) or not. For example the operation input unit 110 detects the actuation of the start key 25 or the encryption key 26 (or 8e). If the operation input unit 110 determines that the e-mail to be transferred is not to be encrypted across the board, the process ends. On the other hand, if the e-mail to be transferred is encrypted across the board, the process proceeds to step S13.

In step S13, the e-mail control unit 130 checks the encryption instruction for the selected address. In particular, the e-mail control unit 130 reads the encryption instruction, corresponding to the administration ID held by the address information holding unit 136, from the address book storage unit 230. In step S14, the e-mail control unit 130 confirms whether the encryption instruction read in step S13 is “POSSIBLE” or “ESSENTIAL”. If the read instruction is “IMPOSSIBLE”, the e-mail control unit 130 determines that the e-mail for the selected address can't be encrypted.

As a result of the at step S14, if the e-mail instruction is not “POSSIBLE” or “ESSENTIAL, the e-mail control unit 130 directs the address holding unit 136 to hold information regarding the selected address. In response to that direction, the address holding unit 136 holds the information at step S15. On the other hand, if the instruction is “POSSIBLE” or “ESSENTIAL”, the process proceeds to the next step.

In step S16, the operation input unit 110 determines whether no addresses are left to process. If the operation input unit 110 determines no, no address data remains, the process returns to step S13. If, on the other hand, the operation input unit 110 determines yes, no address data remains, the process proceeds to the next step.

In step S17, the operation input unit 110 determines whether no addresses are held in the address holding unit 136. If the operation input unit 110 determines no, no address information is held in the address holding unit 136, the process proceeds to step S18 and the operation input unit 110 displays a warning screen on the touch panel 21. On the other hand, if the operation input unit 110 determines yes, no address information is held in the address holding unit 136, the process proceeds to step S19 because the e-mail for all the selected addresses can be encrypted.

In step S19, the e-mail control unit 130 controls the e-mail creating unit 132 and the e-mail encryption processing unit 134 to create the e-mail and encrypt it. Further, in step S20, the e-mail control unit 130 controls the communication unit 140 to send the encrypted e-mail.

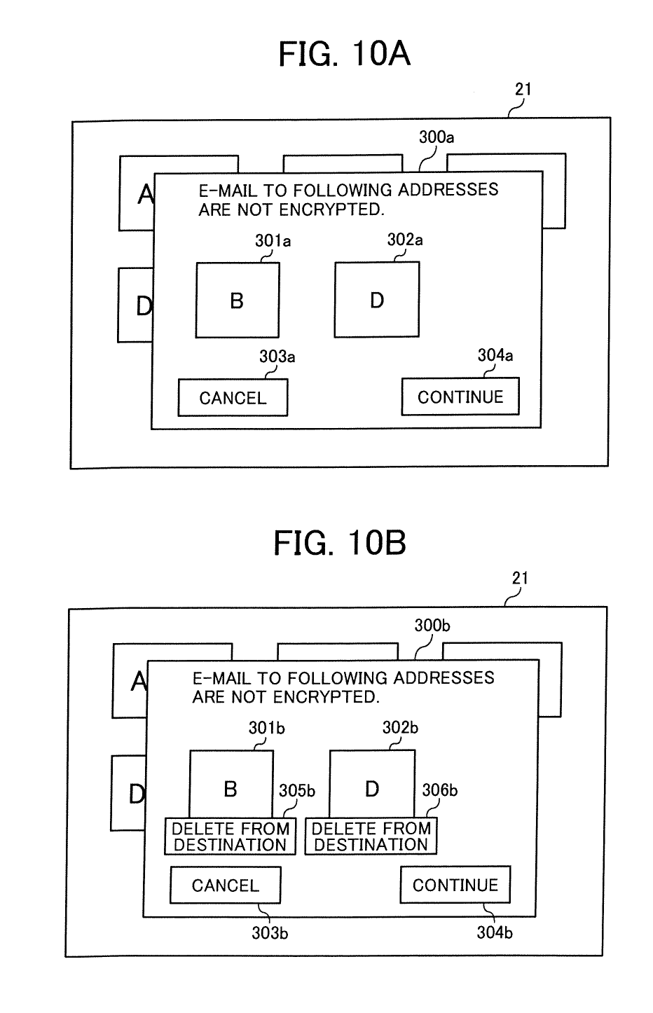

With regard to step S18, that step will be described below with reference to FIG. 10A. FIG. 10A is a diagram showing an example of a warning screen 300a displayed on the touch panel 21 in step S18 described above. On the screen 300a, a message indicating that e-mail, to the addresses having encryption instruction not “POSSIBLE” or “ESSENTIAL” can't be encrypted. Thus, the address icons 301a and 302a having the encryption instruction “IMPOSSIBLE” are displayed. See also FIG. 5.

In addition, a cancel button 303a to cancel sending e-mail and a continue button 304a to continue to send e-mail are provided on the warning screen 300a. If the cancel button is selected, the process to send e-mail to all of the addresses is canceled and the process returns to the screen shown in FIG. 8. On the other hand, if the continue button 304a is selected, the e-mail will be encrypted and sent to each of the addresses except for the addresses B and D. E-mail to the addresses B and D will be sent in plain text.

According to another example, the warning screen may be displayed as shown in FIG. 10B. In this screen, the message, the icons 301b and 302b, the cancel button 303b, and the continue button 304b are the same as shown in FIG. 10A except for the addition of delete buttons 305b and 306b. The delete buttons 305b and 306b enable the deletion of addresses B and D from the destination addresses. If the delete button 305b is selected, the e-mail will be sent to each of the selected addresses except for the address B (i.e., A, C, and D). In this case, the e-mail to the address D is sent in plain text. If the delete button 306b is selected, the process of sending e-mail is the same as the case above, except no e-mail will be sent to D and a plain text e-mail will be sent to B. Further, if the delete button 305b or 306b is selected, the process may return to the flow chart shown in FIG. 9.

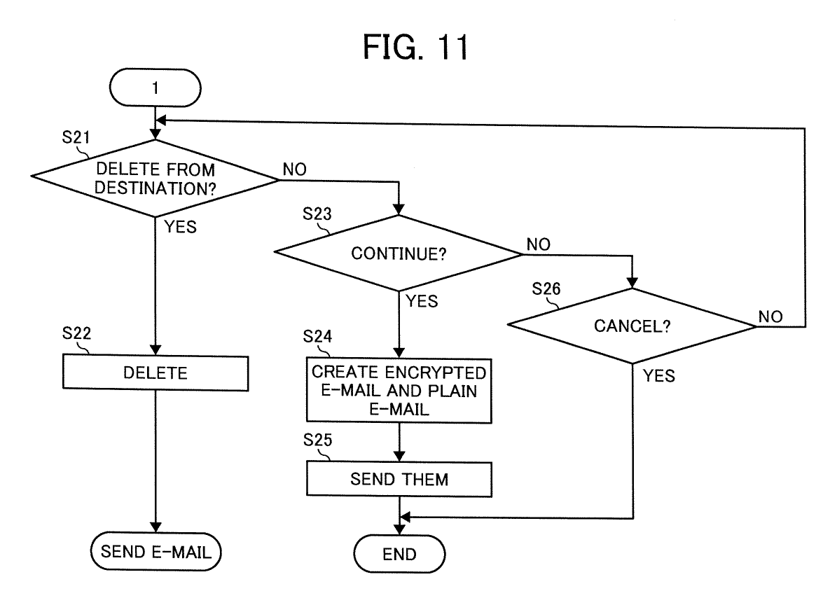

FIG. 11 is a flow chart illustrating an example of processing after displaying one of the warning screens of FIG. 10. In step S21, the operation input unit 110 confirms whether the address displayed in the warning screen 300a or 300b is deleted from the destinations not. For example, the operation input unit 110 detects the selection of the delete button 305b or 306b of FIG. 10B. After this step, the process proceeds to a step S22 if an address is deleted from the destinations.

In step S22, the e-mail control unit 130 deletes the address from the destinations. In particular, the e-mail control unit 130 deletes the address information held in the address holding unit 136. After deleting the address displayed, such as the icon 301a or 302a, and actuating the start key 25, the e-mail control unit 130 signals the e-mail creating unit 132 to create the e-mail and the e-mail encryption unit 134 to encrypt the created e-mail. If the address B or D remains without being deleted from the destination, the e-mail for those addresses aren't encrypted. The encrypted e-mail and plain text e-mail, if any, is sent through the communication unit 140 to the corresponding addresses. The communication unit 140 may output the e-mail to a given mail server on the network and the mail server transfers the e-mail corresponding to the addresses. On the other hand, if the delete button isn't selected, the process proceeds to step S23. Or, if the warning screen doesn't include the delete button as shown in FIG. 10A, the process begins with step S23.

In step S23, the operation input unit 110 confirms whether the continue button 304a or 304b has been selected. If the continue button 304a or 304b has been selected, the process proceeds to step S24.

In step S24, the e-mail control unit 130 signals the e-mail creating unit 132 and the e-mail encryption unit 134 to create e-mail and encrypt it. In this step, the destinations include the address whose encryption instruction is “POSSIBLE” or “ESSENTIAL” and the address whose encryption instruction is “IMPOSSIBLE”. So, the e-mail creating unit 132 creates the e-mail, but the e-mail encryption unit 134 encrypts the former addresses and doesn't encrypt the latter addresses. Thus the e-mail is created, and the process proceeds to step S25.

In step S25, the communication unit 140 sends the encrypted e-mail and the plain text e-mail to the corresponding addresses. The communication unit 140 may output the e-mail to a given mail server as described above. On the other hand, if the operation input unit 110 determines that the continue button 304a or 304b hasn't been selected, the process goes to step S26. In step S26, the operation input unit 110 confirms whether the cancel button 303a or 303b has been selected or not. If the cancel buttons 303a or 303b have been selected, the process ends. On the other hand, if the cancel buttons 303a or 303b haven't been selected, the process returns to step S21 or step S23. For example, this will be the case where no instruction has been received for a given time.

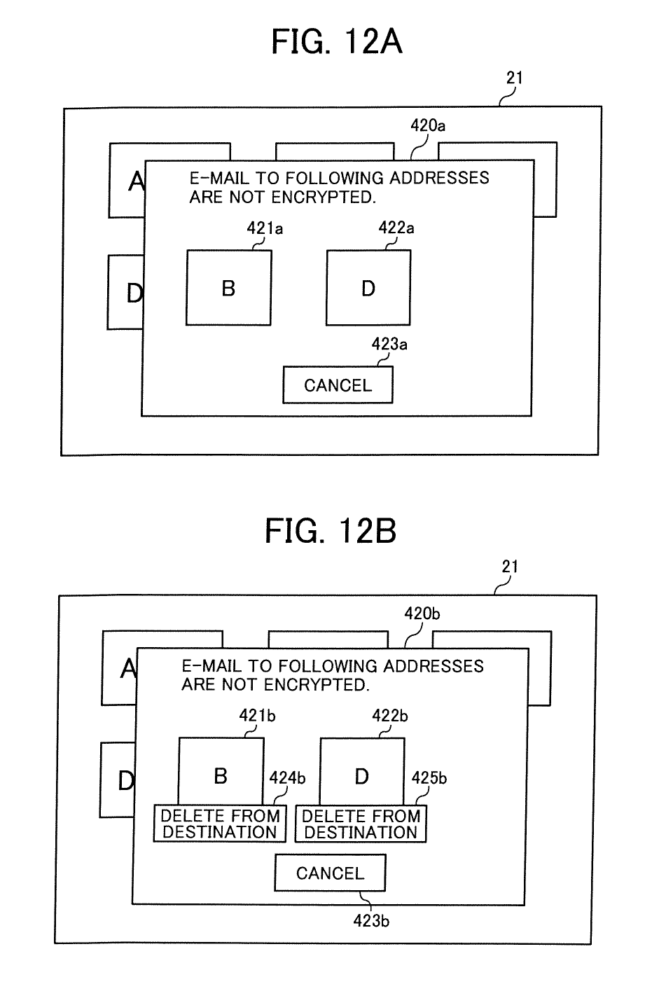

According to another example, the warning screen may be displayed as shown in FIGS. 12A and 12B wherein the continue button aren't included. In FIG. 12A, a warning screen 420a, address icons 421a and 422a, and a cancel button 423a are provided. In FIG. 12B, a warning screen 420b, address icons 421b and 422b, a cancel button 423b, and delete buttons 424b and 425b are provided. Both of the warning screens play the same role as those of FIGS. 10A and 10B. According to FIGS. 12A and 12B, the MFD 1 sends only the encrypted e-mail to corresponding addresses. Thus, the MFD 1 in this embodiment allows the user to send the e-mail only to addresses that can except encrypted e-mail and the e-mail that can't be encrypted across the board can be easily deleted without a complicated operation.

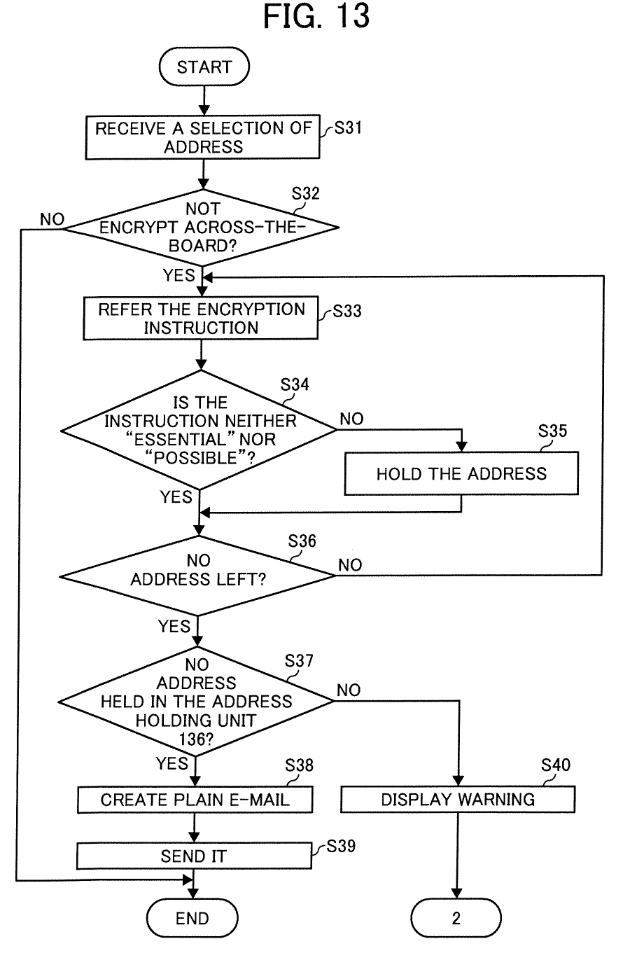

Next, a second embodiment of the invention will be given with reference to FIG. 13. Any overlapping description with regard to the process of the first embodiment will be described briefly. FIG. 13 is a flow chart showing an example of sending e-mail in plain text. In step S31, the operation input unit 110 receives a selection of an address among the destinations displayed by the touch panel 21 and the unit 136 holds the address information in the same way as step S11.

In step S32, the operation input unit 110 determines whether not to encrypt the e-mail across the board. For example, the operation input unit 110 detects a selection of the start key 25 or the encryption key 26 (or 8e). If the operation input unit 110 determines no, do not encrypt the e-mail across the board, the process ends. On the other hand, if the operation input unit 110 determines yes, do not encrypt the e-mail across the board, the process continues to step S33.

In step S33, the e-mail control unit 130 checks the encryption instruction for each address in the same way as step S13. In step S34, the e-mail control unit 130 confirms whether the encryption instruction referred to in step S33 is neither “ESSENTIAL” nor “POSSIBLE”. As a result of this confirmation step, if the answer is no, the e-mail control unit 130 directs the address holding unit 136 to hold address information regarding the selected address. Based on that direction, the address holding unit 136 holds the information in step S35. On the other hand, if the answer in step S4 is yes, the encryption instruction is “IMPOSSIBLE”.

In step S36, the operation input unit 110 determines whether no addresses are left to process in the same way as step S16. If no, no such address data remains, the process returns to step S33. If yes, no address data remains, the process proceeds to the next step, S37.

In step S37, the operation input unit 110 determines whether no addresses are held in the address holding unit 136. If no, no addresses are held in the address holding unit 136, the process proceeds to step S40 and the operation input unit 110 displays a warning screen on the touch panel 21 in the same way as step S18. On the other hand, if yes, no addresses are held in the address holding unit 136, the process proceeds to the next step, S38.

In step S38, the e-mail control unit 130 signals the e-mail creating unit to create plain text e-mail. Further, in step S39, the e-mail control unit 130 signals the communication unit 140 to send the created e-mail.

The difference between this embodiment and the first embodiment of FIG. 9 is the e-mail control unit 130 doesn't control the e-mail encryption unit 134, because the e-mail to be created at step S38 is in plain text if the result of step S37 is “YES”.

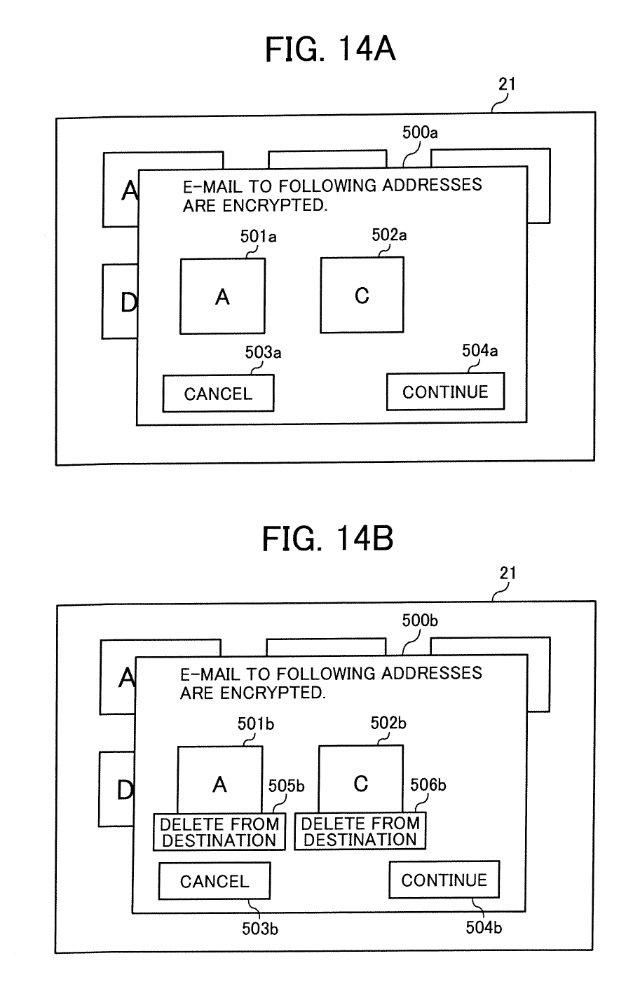

With regard to the process continuing to step S40, that process will be described below with reference to FIGS. 14A and 14B. FIG. 14A is a diagram showing an example of a warning screen 500a displayed on the touch panel 21 in step S40. In the screen 500a, a message indicating the addresses whose encryption instruction was “ESSENTIAL” or “POSSIBLE” is provided. That is, the address icons 501a and 502a reflect the addresses whose encryption instructions are “ESSENTIAL” or “POSSIBLE” in step S34. The address A has the value “ESSENTIAL” and C has the value “POSSIBLE” as shown in FIG. 5.

A cancel button 503a has the same function as the cancel button 303a. If a continue button 504a is selected, an e-mail will be sent to the listed addresses except the addresses A and C will receive the email in plain text, but e-mail to the addresses A and C will be encrypted.

According to another example, the warning screen may be displayed as shown in FIG. 14B. In this screen, the message icons 501b and 502b, a cancel button 503b, and a continue button 504b are the same as the corresponding elements of FIG. 14A except for delete buttons 505b and 506b. The delete buttons have the same function as the corresponding buttons in the first embodiment. In the screen 500a and 500b, it is possible to display an address having an encryption instruction of “ESSENTIAL” or “POSSIBLE”.

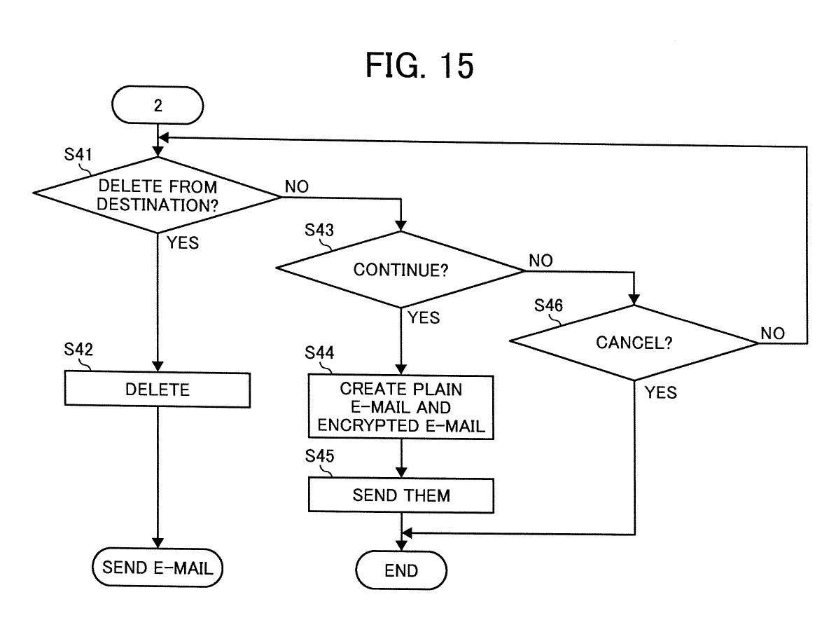

Now a description is provided with reference to FIG. 15 of the process when the warning screen is displayed. The description overlapping with the first embodiment will be provided briefly. In step S41, the operation input unit 110 confirms whether the address displayed in the warning screen 500a or 500b is deleted from the destinations or not in the same way as in step 21.

In step S42, the e-mail control unit 130 deletes the address from the destinations. In addition, the e-mail control unit 130 signals the e-mail creating unit 132 to create the e-mail. Further, the e-mail control unit 130 signals the e-mail encryption unit 134 to encrypt the e-mail for the address which is not deleted from the destinations. The encrypted e-mail and plain text e-mail are sent through the communication unit 140 to the corresponding addresses. The communication unit 140 outputs the e-mail to a given mail server on the network and the mail server transfers the e-mail to the corresponding addresses.

On the other hand, if the delete button isn't selected, the process proceeds to step S43. Or, if the warning screen doesn't include the delete button as shown in FIG. 14A, the process begins with step S43.

In step S43, the operation input unit 110 confirms whether the continue button 504a or 504b is selected in the same way as step S23.

In step S44, the e-mail control unit 130 signals the e-mail creating unit 132 and the e-mail encryption unit 134 to create the e-mail and encrypt it. In this step, the destinations include the addresses whose encryption instruction is “ESSENTIAL”, and the address whose encryption instruction is “POSSIBLE” or “IMPOSSIBLE”. So, the e-mail creating unit 132 creates the e-mail, but the e-mail encryption unit 134 doesn't encrypt the e-mail whose instruction is “POSSIBLE” or “IMPOSSIBLE”.

In step S45, the communication unit 140 sends the encrypted e-mail and the plain text e-mail to the corresponding addresses. The communication unit 140 outputs the e-mail to a given mail server as described above.

On the other hand, if the operation input unit 110 recognizes that the continue button 504a or 504b isn't selected, the process goes to step S46. In step S46, the operation input unit 110 confirms whether the cancel buttons 503a or 503b have been selected or not. If the cancel buttons 504a and 504b have been selected, the process ends. If the cancel buttons 504a or 504b have not been selected, the process returns to step S41 or step S43. For example, the processor returns to step S41 or step S43 when no instruction is received for a given time.

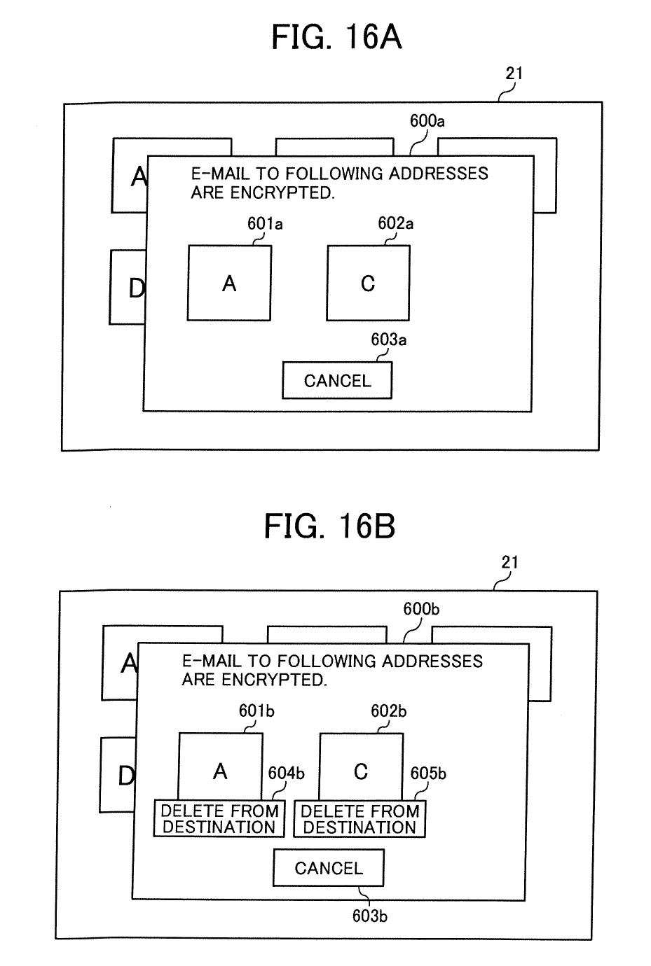

According to another example, the warning screen may be displayed as shown in FIGS. 16A and 16B without the continue button included. In FIG. 16A, a warning screen 600a, address icons 601a and 602a, and cancel button 603a are provided. In FIG. 16B, there are provided the warning screen 600b, the address icon 601b and 602b, the cancel button 603b, and the delete button 604b and 605b. Both of the warning screens play the same role as those of FIGS. 14A and 14B. According to FIGS. 16A and 16B, the MFD 1 sends only the plain text e-mail to corresponding addresses. Thus, the MFD 1 in this embodiment allows the user to send the plain text e-mail easily without a complicated operation even when the e-mail for addresses needing to be encrypted were originally included in the destinations.

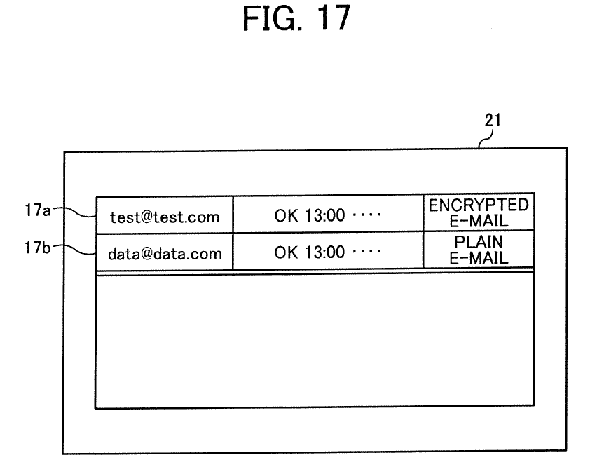

In both of the above described embodiments, it will be convenient to store a record of sent e-mail as shown in FIG. 17. The MFD 1 stores the record in the memory 18 or the secondary storage device 19, for example, so that the operation input unit 110 can display the record on the touch panel 21. Then, the operation input unit 110 displays the record of the encrypted e-mail such as record 17a and the plain text e-mail such as record 17b on the touch panel 21. It may be more useful for the user to display a more detailed screen according to need.

Next, an alternative embodiment will be given with reference to the drawings. In this embodiment, since the hardware layout and software function of the MFD is the same as the embodiments described above, the description of the MFD will be omitted. Also any overlapping description with the embodiments described above will be provided briefly.

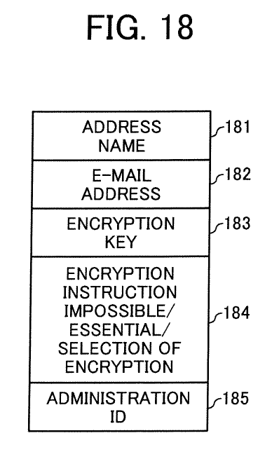

FIG. 18 illustrates an address data structure according to this embodiment. An address name 181, an e-mail address, an encryption key 183, and an administration ID 185 are the same as the corresponding elements shown in FIG. 4.

The encryption instruction 184 includes one of the values “IMPOSSIBLE”, “ESSENTIAL”, or “SELECTION OF ENCRYPTION”. The value “IMPOSSIBLE” and “ESSENTIAL” are the same as the values described with regard to FIG. 4. The value “SELECTION OF ENCRYPTION” indicates that the MFD 1 determines according to the encryption setting entered by the user whether the e-mail should be encrypted or not.

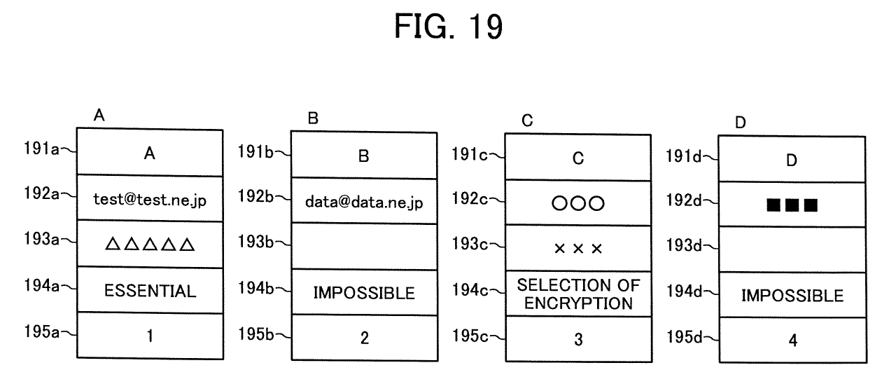

A detailed example of this embodiment will be described with reference to FIG. 19. In FIG. 19, there are four address data structures and each structure corresponds to the user A, user B, user C, and user D. Using the data structures, the information values corresponding to FIG. 18 are described. The information values used are the same values used in FIG. 5 except for the encryption instruction area 194c. In the area 194c, the value “SELECTION OF ENCRYPTION” is the encryption instruction.

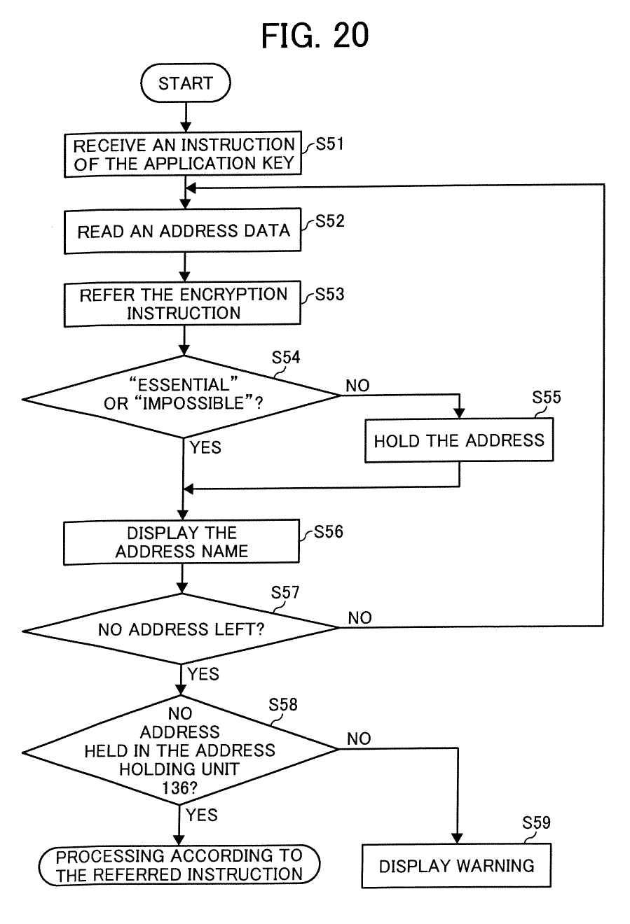

The process of displaying the address information including the “SELECTION OF ENCRYPTION” on the touch panel 21 will now be described with reference to FIG. 20. In step S51 to step S53, the process is conducted in the same manner as the first and second embodiments.

In step S54, the e-mail control unit 130 confirms whether the encryption instruction referred to in step S13 is “ESSENTIAL” or “IMPOSSIBLE”. However, if that instruction is neither “ESSENTIAL” nor “IMPOSSIBLE”, that is, the instruction is “SELECTION OF ENCRYPTION”, the e-mail control unit 130 directs the address holding unit 136 to hold the address information. Based on the received direction, the address holding unit 136 holds the information in step S55. On the other hand, if the e-mail control unit 130 determines that the instruction is “ESSENTIAL” or “IMPOSSIBLE”, the process proceeds to the next step, S56.

In steps S56 and steps S57, the process is conducted in the same way as the first and second embodiments. In step S58, the operation input unit 110 confirms whether address information held in the address holding unit 136 exists or not. If any address information is held in the address holding unit 136, the process proceeds to step S59 and the operation input unit 110 displays a warning screen on the touch panel 21. On the other hand, if no address information is held in the holding unit 136, the processing of e-mail is conducted according to the encryption instruction referred to in step S53, for example, see FIG. 8.

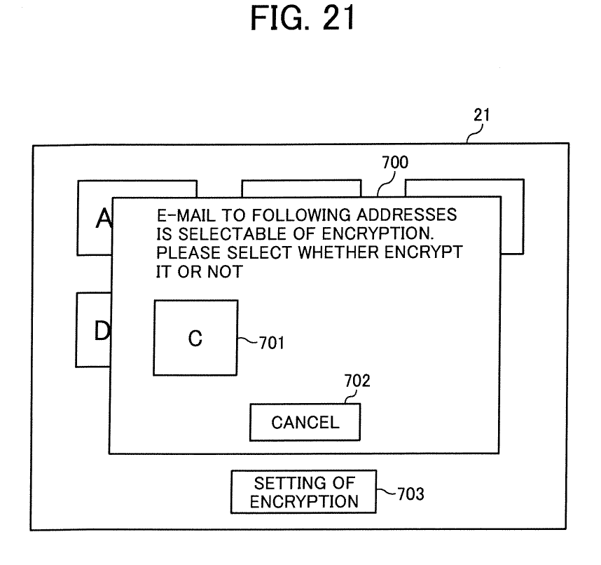

If any address information is held in the address holding unit 136 in step S58, the operation input unit 110 displays a warning screen 700 as shown in FIG. 21 on the touch panel 21. In FIG. 21, a warning screen 700, an icon 701, a cancel button 702, and a setting of encryption button 703 are shown.

On the warning screen 700, a message indicating to the user that encryption can be applied to the email at the user's discretion is displayed. The icon 701 is the same as the corresponding icons of the first and second embodiments described above. That is, the e-mail for the address C requires encryption. The cancel button 702 is for canceling the process. The setting of encryption button 703 is used to configure the encryption setting for e-mail to the address C. The user can configure the e-mail settings, such as selecting the encryption algorithm, by selecting the button 703. In addition, a delete button as shown in the first and second embodiments may be displayed on the warning screen 700. According to this embodiment, the user will be allowed to select the encryption settings of the e-mail for a specific address.

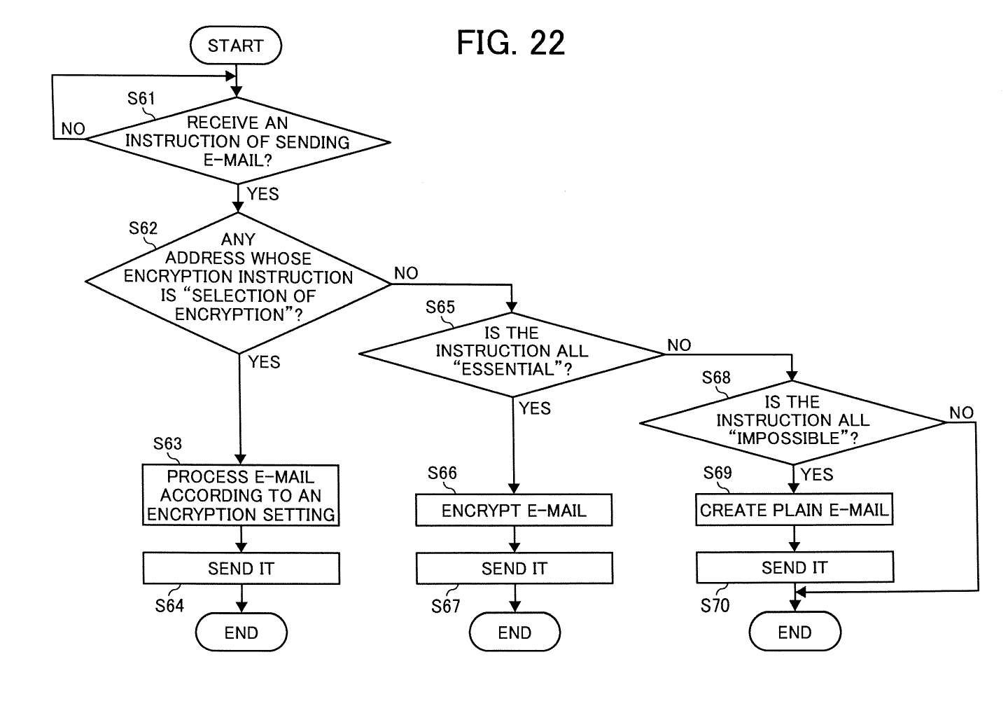

FIG. 22 illustrates another process according to this embodiment using the encryption setting. In this process, the operation input unit 110 doesn't display a warning screen. Further, the confirmation of the encryption instruction is different from other embodiments.

In step S61, the operation input unit 110 confirms whether an instruction to send e-mail is received. If the operation input unit 110 receives such an instruction, the process proceeds to step S62. On the other hand, if no such instruction has been received, the operation input unit 110 continues to await the instruction.

In step S62, the operation input unit 110 confirms the encryption instruction in the same manner as step S58, as shown in FIG. 20. If any address has an encryption instruction “SELECTION OF ENCRYPTION”, the process proceeds to step S63 and is conducted according to the encryption setting. Further, the e-mail according to the encryption setting is sent at step S64.

If none of the addresses have an encryption instruction “SELECTION OF ENCRYPTION”, the process goes to step S65. In this step, the operation input unit 110 confirms whether the encryption instructions are all “ESSENTIAL” or “IMPOSSIBLE”. The process proceeds to next step S66 if all the instructions are “ESSENTIAL”. In step S66, the e-mail control unit 130 controls the e-mail creating unit 132 and the e-mail encryption unit 134 in the same manner as the first and second embodiments described above and the encrypted e-mail is sent in step S67.

On the other hand, if all the encryption instructions aren't “ESSENTIAL”, the process goes to step S68. In this step, the operation input unit 110 confirms whether the encryption instructions are all “IMPOSSIBLE” or not. If all the instructions are “IMPOSSIBLE”, the e-mail control unit 130 controls the e-mail creating unit in step S69 to create e-mail to be sent in plain text in step S70. However, if all the instructions aren't “IMPOSSIBLE”, the process ends because it will be an error in such case. Thus, it is possible for the MFD 1 to confirm the encryption instruction in a different way from the other embodiments described above. Of course, it is possible to appropriately combine embodiments and modifications described above within a limit which avoids contradictions.

A computer readable program according to the present invention causes a computer to carry out the processes described above. More particularly, the computer readable program causes the computer to function as an apparatus such as a communication apparatus described in the various embodiments. The effects of the embodiments described above can be obtained by causing the computer to operate in this manner in accordance with the computer readable program.

A computer readable storage medium according to the present invention stores the computer readable program described above. Any recording media capable of storing the computer readable program in a computer readable manner may form a computer readable storage medium.

The computer readable program may be pre-stored in a storage part or means within the computer, such as the ROM and the HDD. On the other hand, the computer readable program may be stored in a non-volatile recording medium or memory, such as a CD-ROM, flexible disk, a SRAM, an EEPROM, a memory card, a magnetic recording medium, an optical recording medium or a magneto-optical recording medium. The computer-readable program stored in the non-volatile recording medium or memory may be installed into the computer and executed by the CPU or, the CPU may read the computer-readable program from the non-volatile recording medium or memory and execute the computer-readable program, so as to realize the functions of any of the embodiments and modifications described above.

Of course, the computer-readable program may be executed by downloading the computer-readable program from an external equipment that is provided with a recording medium recorded with the computer-readable program or, from an external equipment having a storage part or means stored with the computer-readable program.

Further, the present invention is not limited to the above-described embodiments. Various variations and modifications may be made without departing from the scope of the present invention.

1. A communication apparatus for outputting e-mail to a network comprising:
a storing part configured to store e-mail addresses and related encryption information signifying whether e-mail directed to the addresses should be encrypted or in plain text;
a displaying part configured to display the e-mail addresses stored in the storing unit as selectable destinations by a user;
a receiving part configured to receive an instruction to encrypt e-mail or keep the e-mail in plain text for addresses selected as destinations via the displaying part;
an e-mail control part configured to control creation of the e-mail based on the instruction received by the receiving part and the encryption information related to the selected e-mail addresses; and
an output part configured to output the created e-mail through the e-mail control part to the network.

2. The communication apparatus of claim 1, wherein
the encryption information for each address includes one of the following: a first value indicating that it is impossible for the address to process encrypted e-mail, a second value indicating it is possible to encrypt e-mail for the address, and a third value indicating that it is essential for the address to receive encrypted e-mail;
and the displaying part is further configured to display e-mail addresses which have the second value or the third value with an identification mark indicating the e-mail for those addresses can be encrypted.

3. The communication apparatus of claim 2, wherein the displaying part is further configured to display a screen notifying the user that the selected addresses include an e-mail address having encryption information including the first value when the receiving part receives the instruction to encrypt the e-mail for all the selected addresses, and at least one of the selected addresses has encryption information including the first value.

4. The communication apparatus of claim 3, wherein the displaying part is further configured to display at least one of the following alternative screens:
a first alternative to output e-mail for all selected addresses including the at least on address having the encryption information of the first value,
a second alternative to cancel outputting e-mail for all selected addresses, and
a third alternative to delete the at least one address having the encryption information including the first value from the selected addresses.

5. The communication apparatus of claim 4, wherein the e-mail control part is further configured to control creation of the e-mail in plain text for the addresses having encryption information including the first value when the first alternative is selected, and to control encrypting the e-mail for the remaining addresses selected except for a deleted address when the third alternative is selected.

6. The communication apparatus of claim 2, wherein the displaying part is further configured to display a screen notifying the user that the selected addresses include at least one e-mail address having encryption information including the third value when the receiving part receives the instruction to keep the e-mail in plain text for the selected addresses, and at least one of the selected addresses has encryption information including the second value or the third value.

7. The communication apparatus of claim 6, wherein the displaying part is further configured to display at least one of the following alternative screens:
a first alternative to output e-mail for all selected addresses including the at least one address having the encryption information includes the third value,
a second alternative to cancel outputting e-mail for all selected addresses, and
a third alternative to delete the at least one address having the encryption information including the third value from the selected addresses.

8. The communication apparatus of claim 7, wherein the e-mail control part is further configured to control encryption of the e-mail for the addresses having encryption information including the third value when the third alternative is selected, and to control creation of the e-mail in plain text for the remaining addresses except for a deleted address when the third alternative is selected.

9. A communication apparatus for outputting e-mail to a network comprising;
storing means for storing e-mail addresses and related encryption information signifying whether e-mail directed to the addresses should be encrypted or in plain text,
displaying means for displaying the e-mail addresses stored in the storing means as a selectable destination by a user,
receiving means for receiving an instruction to encrypt the e-mail or keep the e-mail in plain text for addresses selected as destinations via the displaying means,
e-mail control means for controlling creation of the e-mail based on the instruction received by the receiving means and the encryption information related to the selected e-mail addresses;
output means for outputting the created e-mail through the e-mail control means to the network.

10. The communication apparatus of claim 9, wherein
the encryption information for each address includes one of the following: a first value indicating that it is impossible for the address to process encrypted e-mail, a second value indicating it is possible to encrypt e-mail for the address, and a third value indicating that it is essential for the address to receive encrypted e-mail;
and the displaying means display e-mail addresses which have the second value or the third value with an identification mark indicating the e-mail for those addresses can be encrypted.

11. The communication apparatus of claim 10, wherein the displaying means displays a screen notifying the user that the selected addresses include an e-mail address having encryption information including the first value when the receiving means receives the instruction to encrypt the e-mail for all the selected addresses, and at least one of the selected e-mail addresses has encryption information including the first value.

12. The communication apparatus of claim 11, wherein the displaying means displays at least one of the following alternative screens:
a first alternative to output e-mail for all selected addresses including the at least on address having the encryption information of the first value,
a second alternative to cancel outputting e-mail for all selected addresses, and
a third alternative to delete the at least one address having the encryption information including the first value from the selected addresses.

13. The communication apparatus of claim 12, wherein the e-mail control means controls creation of the e-mail in plain text for the addresses having encryption information including the first value when the first alternative is selected, and controls encrypting the e-mail for the remaining selected addresses except for a deleted address when the third alternative is selected.

14. The communication apparatus of claim 10, wherein the displaying means displays a screen notifying the user that the selected addresses include at least one e-mail address having encryption information including the third value when the receiving means receives the instruction to keep all the e-mail in plain text for the selected addresses and at least one of the selected addresses has encryption information including the second value or the third value.

15. The communication apparatus of claim 14, wherein the displaying means displays at least one of the following alternative screens:
a first alternative to output e-mail for all selected addresses including the at least one address having the encryption information includes the third value,
a second alternative to cancel outputting e-mail for all selected addresses, and
a third alternative to delete the at least one address having the encryption information including the third value from the selected addresses.

16. The communication apparatus of claim 15, wherein the e-mail control means controls encryption of the e-mail for the addresses having encryption information including the third value when the third alternative is selected, and creates the e-mail in plain text for the remaining addresses except for a deleted address when the third alternative is selected.

17. A control method for a communication apparatus which outputs e-mail to a network comprising the steps of:
storing e-mail addresses and related encryption information signifying whether e-mail directed to the address should be encrypted or in plain text in a storage device;
displaying the e-mail addresses stored in the storage device so as to be selectable as a destination by a user;
receiving an instruction to encrypt e-mail or keep the e-mail in plain text for addresses selected as destinations during the displaying step;
controlling creation of the e-mail based on the instruction received during the receiving step and the encryption information related to the selected e-mail addresses; and
outputting the created e-mail to the network.

18. A computer program product stored on a recording medium and which causes a computer to output e-mail to a network, comprising the steps of:
storing e-mail addresses and related encryption information signifying whether e-mail directed to the address should be encrypted or in plain text in a storage device;
displaying the e-mail addresses stored in the storage device so as to be selectable as a destination by a user;
receiving an instruction to encrypt e-mail or keep the e-mail in plain text for addresses selected as destinations during the displaying step;
controlling creation of the e-mail based on the instruction received during the receiving step and the encryption information related to the selected e-mail addresses; and
outputting the created e-mail to the network.
